(19) United States
(12) Patent Application Publication
(10) Pub. No.: US 2011/0226341 A1
(43) Pub. Date: Sep. 22, 2011

(54) DEVICE AND METHOD FOR REUSING GREYWATER

(75) Inventors: Johannes Donaes, Jacobus Platteel, Muiden (NL); Shaun Stuart Murdoch, Kortgene (NL)

(73) Assignee: ECOPLAY INTERNATIONAL B.V., Muiderberg (NL)

(21) Appl. No.: 13/057,885

(22) PCT Filed: Jul. 28, 2009
(86) PCT No.: PCT/NL2009/050465

§ 371 Date: Jun. 1, 2011

(30) Foreign Application Priority Data
Aug. 7, 2008 (NL) 1035800

(51) Int. Cl. F16K 49/00; F17D 3/00

(52) U.S. Cl. 137/1; 137/340

(57) ABSTRACT

The present invention relates to a device for reusing greywater, comprising: a water feed (2) for supplying the greywater to be reused, a storage tank (4) for storing the greywater, a water discharge (6) for discharging water stored in the storage tank to a water-consumer (8), and a heat exchanger (10) for extracting heat from the supplied greywater. The invention also relates to a method for reusing greywater using such a device.

The present invention relates to a device for reusing greywater, also referred to hereinbelow as greywater device, and to a method for applying thereof.

Diverse energy standards have been drawn up by government authorities in order to relieve pressure on the environment. One of these is the Energy Performance Standard (EPS) which expresses the energy efficiency of new housing in the so-called Energy Performance Coefficient (EPC). The EPC represents the energy consumption of a building relative to a similar reference building described in the standard (for dwellings and residential buildings in the Netherlands this is currently NEN 5128/2001). This EPC is calculated on the basis of the building properties (insulation value of walls, floors, glazing and so on) and installations (for instance solar collectors, ventilation systems and heating). The lower the number, the greater the energy efficiency of the building. The Energy Performance Coefficient (EPC) can thus be deemed as a measure for the (average) energy quality of a building, including technical installations. The level of the EPC is laid down in the Buildings Decree in the form of a minimum EPC requirement, set as of 1 Jan. 2006 at 0.8. All newly built houses must satisfy this maximum allowed EPC. In addition, there is a trend for local authorities to individually set stricter requirements, such as for instance an EPC of 0.6, and it is anticipated that in due course this will be adopted nationwide.

The energy consumption is determined on the basis of, among other factors, the energy consumption for heating, hot tap water, pumps, cooling, fans and lighting. If a newly built house does not achieve an EPC of 0.8, this means that additional measures must be applied, such as solar panels and/or triple glazing, and this can markedly increase the cost of building a house.

One method of making efficient use of energy and the environment is to reuse lightly contaminated water. Instead of using mains water, which is treated with considerable effort and at great cost in wastewater purification plants, less clean non-potable water can be used for some applications, such as for instance flushing the toilet. It is thus possible to envisage applying collected rainwater and the reuse of lightly contaminated bath and shower water, also referred to as greywater. This saving of water moreover also results in a proportional reduction in the load on the sewage system.

The use of relatively warm greywater, such as shower water, also has another favourable effect on the Energy Performance Coefficient (EPC): there is a reduction in the “cold source” which normally occurs when cold mains water is fed into and stored in a cistern.

Although the currently known and commercially available greywater devices, including the Ecoplay® system of applicant, already have a favourable effect on the energy consumption in a dwelling through the use of greywater, for instance for flushing a toilet, it is desirable to further improve the currently known systems.

The present invention has for its object to provide a device and method for reusing greywater, wherein the above stated problems are at least partially obviated and wherein the energy consumption in particular is further reduced.

Said object is achieved with the device for reusing greywater according to the present invention, comprising: a water feed for supplying the greywater to be reused; a storage tank for storing the greywater; a water discharge for discharging water stored in the storage tank to a water-consumer; and a heat exchanger for extracting heat from the supplied greywater.

The temperature of the greywater stored in the storage tank is an important parameter for the storage life of the greywater. At higher temperatures culture growth and the associated development of undesirable odours will occur sooner. Because the heat exchanger extracts heat from the greywater, this greywater is cooled and the storage life thereof is increased.

According to a preferred embodiment, the heat exchanger is adapted to heat mains water with the heat extracted from the greywater. The storage life of the greywater is increased, and the heat extracted from the greywater is also applied in useful manner for the purpose of heating mains water. When for instance a shower is used, warm greywater is discharged via the drain of the shower and delivered to the greywater device. Warm water is on the other hand also desired during use of a shower. The mains water employed for this purpose is already preheated with the heat exchanger, whereby the heat of the greywater originating from the shower use is usefully applied. Less additional heating is required than would be the case if non-preheated mains water were used. In addition to an increased storage life of the greywater, the system hereby also results in an energy-saving in the heating of the shower water to the desired water temperature.

In addition, it is also possible to envisage that the heat extracted from the greywater by the heat exchanger, instead of being used to heat the water of the shower which simultaneously produces warm greywater, is used for another water consumer such as a hot water tap or, if desired, for heat storage in a storage unit.

During warm periods the heat exchanger can contribute toward reducing the EPC of a dwelling in that the heat exchanger cools the greywater and discharges the heat outside the dwelling. Because the greywater device with cooled greywater will heat the dwelling to less extent as “warm source”, this prevents the occupants of the house activating an air-conditioning system as a result of heat radiated by the greywater device. The EPC of a dwelling in which the greywater device with heat exchanger is placed will hereby also be reduced further during warm periods.

According to a further preferred embodiment, the heat exchanger comprises a compact unit. Although it is possible to envisage the heat exchanger being arranged in substantially upright orientation for the purpose of extracting heat from the discharge conduit water flowing through the discharge conduit, and herein being able to span a height difference up to 1.80 m, this is not possible in all cases. This is because such a height difference is not available when the shower is situated on the same floor as the greywater device. Due to the increase in single-storey dwellings such as apartments, it will more often be necessary for the heat exchanger to operate over a small height. In known conventional heat exchangers, arranged for instance round the discharge conduit between an upper floor where the shower is situated and a lower floor where the water consumer (for instance a toilet) is situated, this is not the case.

According to a further preferred embodiment, the heat exchanger comprises a maximum height dimension of 1 m, more preferably comprises a maximum height dimension of 50 cm, and still more preferably comprises a maximum height dimension of 30 cm. When the heat exchanger comprises an above stated maximum height dimension, the heat exchanger can also be applied within single-storey dwellings, i.e. when the greywater supply (shower) and water consumer (toilet) are situated on the same floor. The maximum height dimension can for instance be 50 cm, 45 cm, 40 cm, 35 cm, 30 cm, 25 cm or 20 cm.

According to yet another preferred embodiment, the device further comprises a frame in which at least the storage tank and the heat exchanger are accommodated. By integrating the heat exchanger in the frame of the greywater device, the greywater device provided with the heat exchanger can easily be placed as module by a fitter in a relatively short period of time.

According to yet another preferred embodiment, the device is further provided with a control system, and the heat exchanger comprises sensors connecting to the control system. The control system can for instance hereby switch off the greywater device when a leak is detected in order to prevent greywater and mains water being able to come into contact with each other.

In addition, the effectiveness of the heat exchanger can be determined on the basis of water temperatures measured by sensors in the heat exchanger and, if desired, be fed back to the owner and/or manufacturer of the greywater device.

In a preferred embodiment the heat exchanger comprises sensors for detecting an (imminent) blockage, which can take place for instance by measuring changes in the electrical conduction between contact points arranged in the heat exchanger.

According to yet another further preferred embodiment, the device further comprises: a collecting reservoir for collecting the supplied greywater; a siphon connection arranged substantially in the central part of the collecting reservoir arranged in substantially upright position; and siphoning means for siphoning water from the collecting reservoir to the storage tank via the siphon connection. The separating principle applied in accordance with this configuration is based on a difference in specific weight between the collected greywater and the contaminants present in the water. Contaminants with a density greater than water, such as grains of sand, will sink and be situated substantially in the bottom part of the collecting reservoir. Light contaminants such as soap residues will float, and therefore be situated substantially close to the top of the water level in the collecting reservoir. Siphoning from the central part has the advantage that the collected greywater is here relatively the cleanest. For the purpose of siphoning use is preferably made of the physical principle that in the case of two vessels (here the collecting reservoir and the storage tank) which are connected to each other, at equilibrium the liquid levels in the two vessels will be at the same height. This equilibrium can be temporarily disturbed by a fresh supply of greywater to the collecting reservoir or by discharge of greywater stored in the storage tank to a water consumer. Owing to this physical law of communicating vessels a pump is unnecessary, and the device is energy-efficient in use and also cheaper to manufacture.

Conventional heat exchangers are normally not applied with greywater because of the required physical flow properties, and because the heat exchanger may become fouled by the contaminants present in the greywater. Heat exchangers which can be applied with greywater are proposed hereinbelow in different aspects.

According to a preferred embodiment, the heat exchanger comprises: a housing comprising at least a top side and a bottom side; a water feed arranged close to the top side of the housing for the purpose of supplying greywater; one or more plate parts arranged at an incline in the housing for the purpose of guiding thereover greywater supplied by the water feed; a water discharge arranged close to the bottom side of the housing for discharging greywater to the storage tank and/or the collecting reservoir; wherein one or more flow channels are provided in the plate parts for the purpose of guiding therethrough mains water to be heated; and wherein a heat-transferring connection between plates of the plate parts and the flow channels is provided such that heat transfer takes place between the relatively warm greywater flowing over the plates and the mains water for heating which is cooler relative thereto. This configuration provides a heat exchanger which is of compact construction and, despite the limited overall height, has been found in tests to be able to achieve efficiencies of at least 50%.

According to a further preferred embodiment, a plurality of plates arranged at an incline and in zigzag manner in the housing guide the water flow downward through the housing between the feed and discharge. By applying a plurality of plates in a zigzag configuration the length of the housing of the heat exchanger can be limited, while the greywater still flows over a sufficiently large surface area to obtain the desired heat transfer. The heat exchanger can be embodied as compact unit.

According to yet another preferred embodiment, the obliquely arranged plates comprise an incline of preferably between 1°-15°, and more preferably they comprise an incline of substantially between 3°-10°.

According to another further preferred embodiment, the flow speed of the greywater over the plates preferably lies between 0.1-1.5 m/s, and more preferably between 0.3-0.7 m/s. Tests have shown that such a relatively high speed produces a good heat transfer. The greywater is displaced as film relatively quickly over the plates of the plate parts, and the water demanded for instance for shower use will also have to flow relatively quickly through the flow channels in order to achieve a balance in volume flow.

According to another further preferred embodiment, the heat-transfer contact surface between the flow channels and the plates is enlarged by applying non-round flow channels. Because the heat-transfer contact surface is enlarged, the heat transfer increases. The greywater will hereby be further cooled, this being favourable for the storage life thereof. In addition, less additional heating of the mains water will be required in order to reach for instance a desired water temperature for showering.

According to yet another preferred embodiment, the heat-transfer contact surface between the flow channels and the plates is enlarged by deforming this contact surface. The contact surface is for instance enlarged by folding the surface or providing it with protruding parts, whereby the achievable heat transfer increases.

According to yet another further preferred embodiment, the one or more flow channels are oriented substantially in the flow direction, and the flow direction through the flow channels of the mains water for heating is substantially opposite to the flow direction of the warm greywater flowing over the plates. The mains water for heating flows through the one or more flow channels in a direction opposite to the greywater flowing over the plates, thereby creating a counterflow which has good heat transfer properties.

According to another further preferred embodiment, the flow direction of the mains water through the flow channels is oriented substantially transversely of the flow direction of the greywater flowing over the plates. Mains water flows substantially transversely of the flow direction of the greywater and meanders so that a relatively large part of the surface of the plate is used for extracting heat from the greywater, and this extracted heat is transferred to the mains water flowing through the flow channels.

According to yet a further preferred embodiment, screening plates are provided under the flow channels which are adapted to screen the flow channels arranged under the plates from splashing greywater. The reliability of the system is increased by strictly separating the greywater and mains water.

According to yet another further preferred embodiment, the screening plates are also adapted, in the case of a leakage in a flow channel, to collect and discharge the water leaking out of this flow channel via an indicator channel. When leaking water is present in this indicator channel, the user can be alerted and, if desired, the greywater device can be switched off via the control system.

The invention further relates to a method for reusing greywater, comprising the steps of: supplying greywater for reuse to a water feed of a greywater device; extracting heat from the supplied greywater with a heat exchanger, herein cooling the greywater; storing the somewhat cooled greywater in a storage tank of the greywater device; and discharging water stored in the storage tank via a water discharge to a water consumer.

According to a further preferred embodiment of the method, the heat exchanger heats mains water with the heat extracted from the greywater.

According to another further preferred embodiment, a device is applied as described above.

Preferred embodiments of the present invention are further elucidated in the following description on the basis of the drawing, in which:

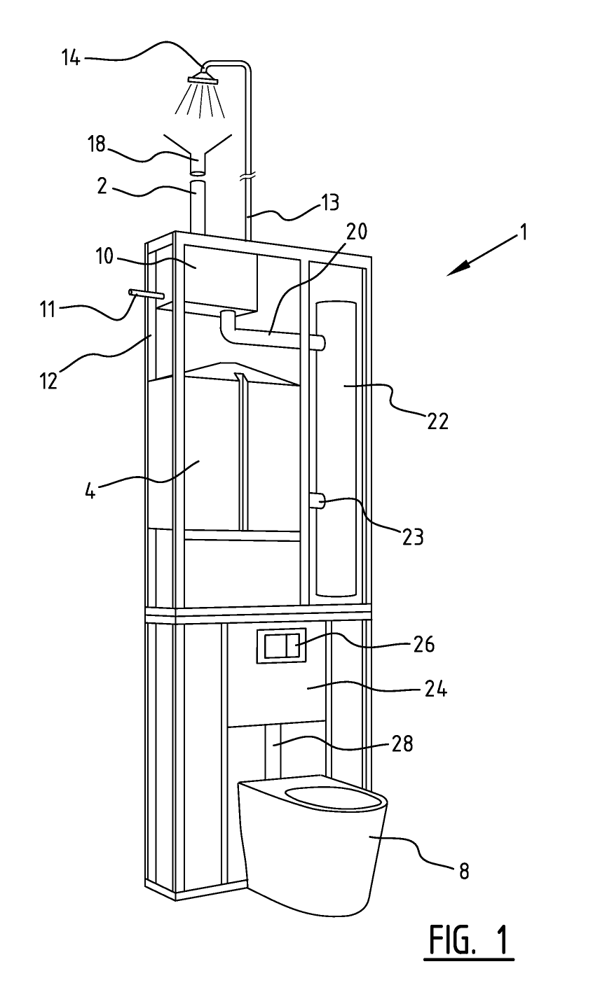

FIG. 1 is a perspective view of a greywater device according to the present invention;

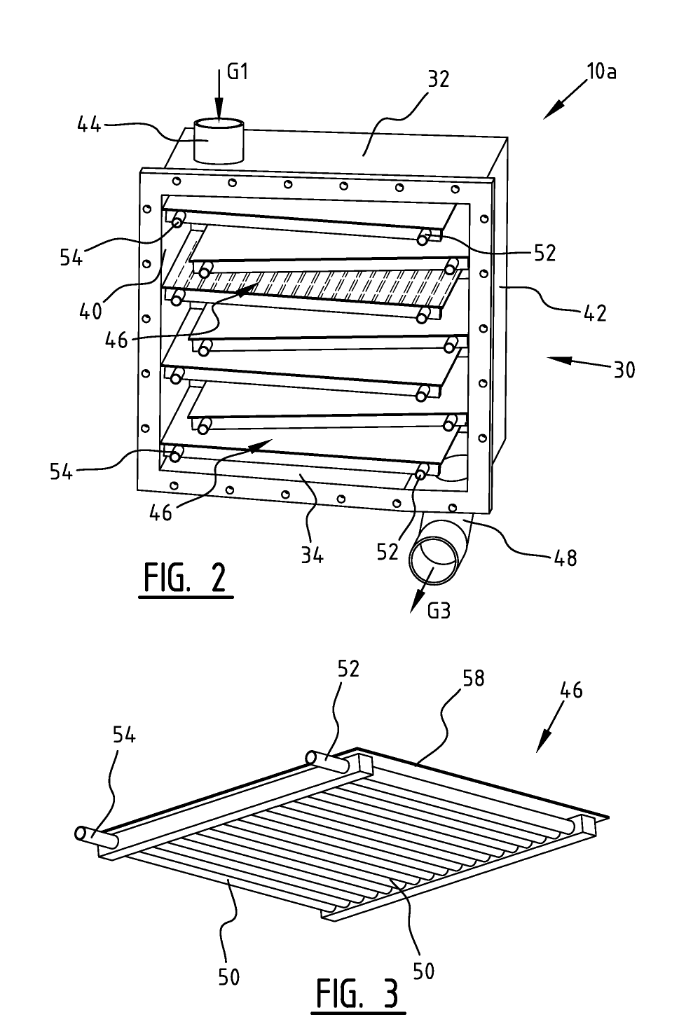

FIG. 2 is a perspective view of a heat exchanger according to a first aspect of the present invention;

FIG. 3 is a perspective bottom view of a plate part of the heat exchanger shown in FIG. 2;

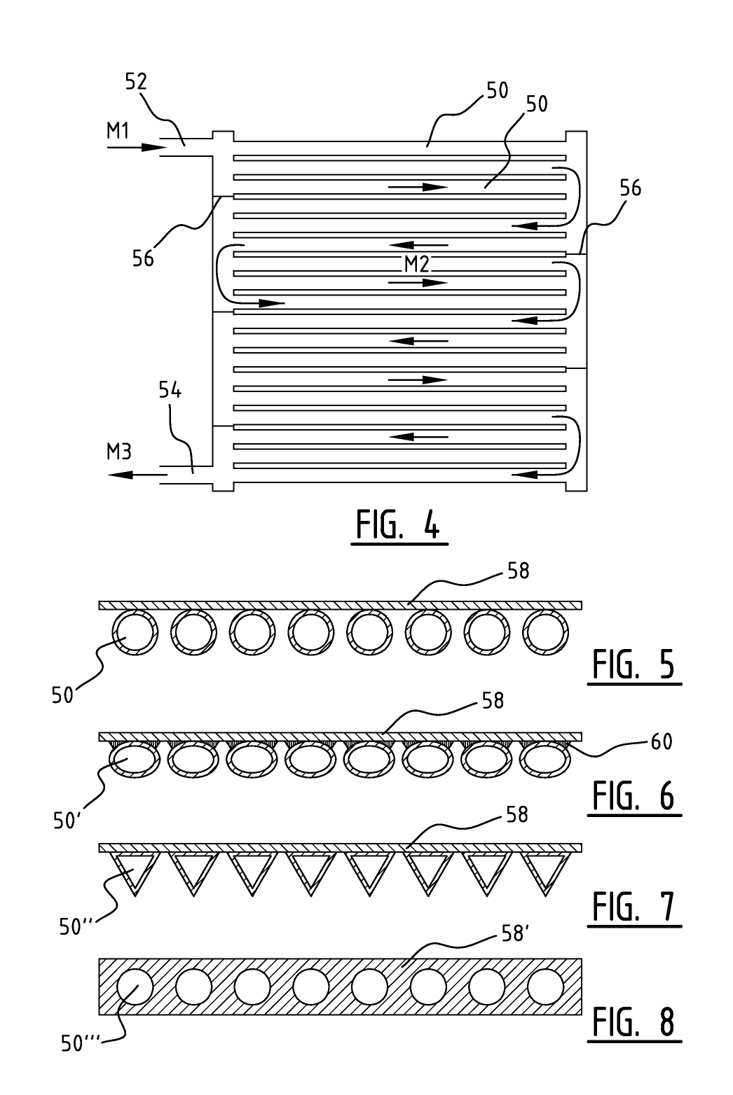

FIG. 4 is a top view of the plate parts shown in FIGS. 2 and 3;

FIG. 5 is a cut-away side view of a first embodiment of a plate part;

FIG. 6 is a cut-away side view of a second embodiment of a plate part;

FIG. 7 is a cut-away side view of a third embodiment of a plate part;

FIG. 8 is a cut-away side view of a fourth embodiment of a plate part, wherein the flow channels and the plates of the plate part are integrated;

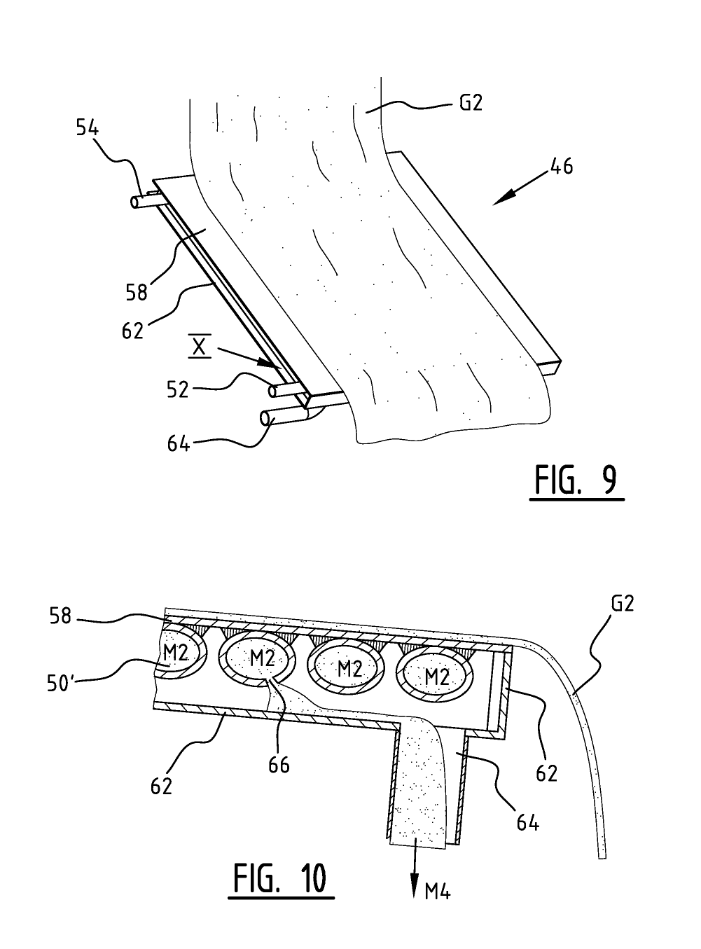

FIG. 9 is a perspective view of a plate part over which greywater is flowing; and

FIG. 10 is a cut-away detail view of the view shown in FIG. 9, wherein the situation of a leaking flow channel is shown.

The greywater device 1 shown in FIG. 1 has a water feed 2 through which water from a greywater source, here shower 14, is supplied to a heat exchanger 10. In this heat exchanger 10 the supplied greywater, which is normally warm, is cooled in order to improve the storage life of the greywater in greywater device 1. Heat exchanger 10 has a conduit 20 which guides to a collecting reservoir 22 the greywater guided through heat exchanger 10. It is noted that, instead of delivery to a collecting reservoir 22 as applied in the Ecoplay® greywater system developed by applicant, the water discharged from heat exchanger 10 can also be carried directly to a storage tank 4.

The heat extracted from the greywater by heat exchanger 10 is preferably used to preheat mains water. Mains water is supplied to heat exchanger 10 via a supply conduit 11. After heating, this preheated mains water is supplied via a conduit 13, via for instance a geyser, to shower 14.

Use is made in collecting reservoir 22 of a separating principle based on the idea that heavy contaminants will sink and light contaminants will float. The relatively cleaner water is thus situated substantially in the central part of the collecting reservoir 22 in substantially upright position, from where it is siphoned via a siphon connection 23 to storage tank 4. When a user operates the operating element 26 of the toilet, water from greywater device 1 will be used to flush toilet 8.

As shown here, toilet 8 can be provided with its own water tank 24, but can also comprise a reservoir combined with greywater device 1.

Heat exchanger 10 shown in FIG. 1 will be provided with greywater comprising contaminants such as sand residues, hair, flakes of skin and soap residues, this making particular demands of the heat exchanger. Furthermore, heat exchanger 10 preferably takes a compact form such that it extracts sufficient heat from the supplied greywater over a small height and can still be built into frame 12 of greywater device 1. When greywater device 1 is accommodated together with heat exchanger 10 in one frame, it can easily be placed in a dwelling as module and in a relatively short period of time by a fitter.

FIGS. 2-10 show a heat exchanger 10a according to a first aspect of the present invention. Heat exchanger 10a has a housing 30 consisting of a top side 32, a bottom side 34, a front side (not shown), a rear side (not shown), a left side 40 and a right side 42. Arranged close to top side 32 of housing 30 is a water feed 44 through which is supplied greywater fed to heat exchanger 10a. This supplied greywater G1 will move downward through housing 30 via a number of plate parts 46 arranged in zigzag manner and inclining to some extent, after which it is fed through a water discharge 48 of housing 30 via conduit 20 to collecting reservoir 22 or, if desired (not shown), directly to a storage tank 4 or to the sewer.

In the embodiment shown in FIG. 2 seven plate parts 46 are shown. FIG. 3 shows a perspective bottom view of one such plate part 46, which is constructed from a plate 58 and a number of flow channels 50 which are arranged thereunder and through which mains water for heating can be guided. Flow channels 50 arranged under plate 58 comprise an inlet channel 52 and an outlet channel 54.

As shown in FIG. 4, baffles 56 are also provided which guide the mains water supplied via inlet channel 52 in flow direction M1 meandering through flow channels 50 in the direction of outlet channel 54, where it leaves plate part 46 in flow direction M3. Flow direction M2 lies substantially transversely of the flow direction of the greywater G2 flowing over plate 58.

Although it is possible to envisage flow channels 50 comprising tubes with a round section coupled in heat-transferring manner to plate 58 (FIG. 5), it is recommended to give channels 50 a non-round form and thereby enlarge the contact surface between the flow channels and plate 58. The embodiment of FIG. 6 has for this purpose oval-shaped flow channels 50′ connected to plate 58 by means of a heat-transferring connection 60. In FIG. 7 an alternative triangular flow channel 50″ is applied. The embodiment shown in FIG. 8 relates to a plate part in which flow channel 50″ and plate part 58′ are integrated into each other.

The perspective view shown in FIG. 9 of plate part 46 shows how the greywater displaces as a film G2 over plate 58. FIG. 9 also shows a leakage indicator channel 64, the action of which will be further elucidated with reference to FIG. 10. FIG. 10 shows a sectional view of a plate part 46, wherein greywater G2 is displaced as a film over plate 58. When a leakage occurs in a flow channel 50′, water will flow out of flow channel 50′ onto screening plate 62 and, due to the inclining position of plate part 46, be guided to a leakage indicator channel 64, from where it is discharged. As soon as the system detects water in a conduit or hose connected to leakage indicator channel 64, the user is alerted or, if desired, greywater system 1 is blocked. The possibility of mains water coming into contact with greywater, which could result in very undesirable situations and associated health risks, can in this way be prevented at all times. The leaking mains water is discharged via channel 64 in flow direction M4, where it can be detected if desired.

Although they show preferred embodiments of the invention, the above described embodiments are intended only to illustrate the present invention and not in any way to limit the specification of the invention. The scope of the invention is therefore defined solely by the following claims.

1. Device for reusing greywater, comprising:
a water feed for supplying the greywater to be reused;
a storage tank for storing the greywater;
a water discharge for discharging water stored in the storage tank to a water-consumer; and
a heat exchanger for extracting heat from the supplied greywater.

2. Device as claimed in claim 1, wherein the heat exchanger is adapted to heat mains water with the heat extracted from the greywater.

3. Device as claimed in claim 1, wherein the heat exchanger comprises a compact unit.

4. Device as claimed in claim 1, wherein the heat exchanger comprises a maximum height dimension of 1 m.

5. Device as claimed in claim 1, further comprising a frame in which at least the storage tank and the heat exchanger are accommodated.

6. Device as claimed in claim 1, wherein the device is further provided with a control system, and the heat exchanger comprises sensors connecting to the control system.

7. Device as claimed in claim 1, further comprising:
a collecting reservoir for collecting the supplied greywater;
a siphon connection arranged substantially in the central part of the collecting reservoir arranged in substantially upright position; and
siphoning means for siphoning water from the collecting reservoir to the storage tank via the siphon connection.

8. Device as claimed in claim 1, wherein the heat exchanger comprises:
a housing comprising at least a top side and a bottom side;
a water feed arranged close to the top side of the housing for the purpose of supplying greywater;
one or more plate parts arranged at an incline in the housing for the purpose of guiding thereover greywater supplied by the water feed;
a water discharge arranged close to the bottom side of the housing for discharging greywater to the storage tank and/or the collecting reservoir;
wherein one or more flow channels are provided in the plate parts for the purpose of guiding therethrough mains water to be heated; and
wherein a heat-transferring connection between plates of the plate parts and the flow channels is provided such that heat transfer takes place between the relatively warm greywater flowing over the plates and the mains water for heating which is cooler relative thereto.

9. Device as claimed in claim 8, wherein a plurality of plates arranged at an incline and in zigzag manner in the housing guide the water flow through the housing between the feed and discharge.

10. Device as claimed in claim 8, wherein the obliquely arranged plates comprise an incline of between 1°-15°.

11. Device as claimed in claim 1, wherein the flow speed of the greywater over the plates lies between 0.1-1.5 m/s.

12. Device as claimed in claim 1, wherein the heat-transfer contact surface between the flow channels and the plates is enlarged by applying non-round flow channels.

13. Device as claimed in claim 1, wherein the heat-transfer contact surface between the flow channels and the plates is enlarged by at least partially deforming this contact surface.

14. Device as claimed in claim 1, wherein the one or more flow channels are oriented substantially in the flow direction, and the flow direction of the mains water through the flow channels is substantially opposite to the flow direction of the greywater flowing over the plates.

15. Device as claimed in claim 1, wherein the flow direction of the mains water through the flow channels is oriented substantially transversely of the flow direction of the greywater over the plates.

16. Device as claimed in claim 1, wherein screening plates are provided under the flow channels which are at least adapted to screen the flow channels arranged under the plates from splashing greywater.

17. Device as claimed in claim 16, wherein the screening plates are also adapted, in the case of a leakage in a flow channel, to discharge the water leaking out of this flow channel.

18. Method for reusing greywater, comprising the steps of:
supplying greywater for reuse to a water feed of a greywater device;
extracting heat from the supplied greywater with a heat exchanger, herein cooling the greywater;
storing the somewhat cooled greywater in a storage tank of the greywater device; and
discharging water stored in the storage tank via a water discharge to a water-consumer.

19. Method as claimed in claim 18, further comprising the step that the heat exchanger heats mains water with the heat extracted from the greywater.

20. Method as claimed in claim 18, wherein a device as claimed in claim 1 is applied.

21. Device as claimed in claim 1, wherein the heat exchanger comprises a maximum height dimension of 50 cm.

22. Device as claimed in claim 1, wherein the heat exchanger comprises a maximum height dimension of 30 cm.

23. Device as claimed in claim 8, wherein the obliquely arranged plates comprise an incline of substantially between 3°-10°.

24. Device as claimed in claim 1, wherein the flow speed of the greywater over the plates lies between 0.3-0.7 m/s.
